(19) United States
(12) Patent Application Publication
(10) Pub. No.: US 2004/0105072 A1
(43) Pub. Date: Jun. 3, 2004

(54) Polarizing plate and plastic optical article

(75) Inventors: Xuzhi Qin, Hacienda Heights, CA (US); Hideyo Sugimura, North Oaks, MN (US)

Correspondence Address: INSKEEP INTELLECTUAL PROPERTY GROUP, INC, 1225 W. 190TH STREET, SUITE 205, GARDENA, CA, 90248, US

(73) Assignee: Vision-Ease Lens, Inc.

(21) Appl. No.: 10/684,202

(22) Filed: Oct. 10, 2003

Related U.S. Application Data
(60) Provisional application No. 60/418,015, filed on Oct. 10, 2002.

(51) Int. Cl. G02B 3/00; B29D 11/00

(52) U.S. Cl. 351/163; 264/1.32

(57) ABSTRACT

A plastic optical article manufactured by an insert injection molding process comprises an injected thermoplastic base and a polarizing plate comprising a polarizing film, a thermoplastic support layer bonded to one surface of the polarizing film, and a thermoplastic protective layer bonded to the other surface of the polarizing film. The thermoplastic support layer is constructed from the same or similar material as the thermoplastic base. The thermoplastic protective layer is constructed from a resin sheet having an optical retardance of less than 200 nm in order to minimize the reduction of polarization efficiency by a birefringent material. The plastic optical article does not show interference fringe colors of polarized light if the protective layer faces the polarized light source. The polarizing plate is useful for manufacturing polarized eyewear articles, such as polarized sunscreens and goggles.

### CROSS REFERENCE TO RELATED APPLICATIONS

This application claims the benefit of priority from U.S. Provisional Application Serial No. 60/418,015 filed on Oct. 10, 2002, the entire contents of which are incorporated by reference.

### BACKGROUND OF THE INVENTION

This invention relates to a polarizing optical article containing a polarizing plate comprising a thermoplastic support layer, a polarizing film, and a thermoplastic protective layer. This invention particularly relates to a polarizing plate comprising an optically isotropic, thermoplastic protective layer. The polarizing plate has excellent polarization efficiency, and does not show a colored interference fringe when viewed with the protective layer facing a polarizing source. The polarizing plate of this invention can be advantageously incorporated into a plastic optical article for eyewear, such as a sunglass lens or a sport goggle plate, by using an insert injection molding process.

Plastic ophthalmic lenses made from materials such as polycarbonate and CR-39 have become popular due to their low cost and light weight relative to glass lenses. Polycarbonate lenses have superior impact resistance compared to CR-39 lenses, and are preferred for applications that require additional safety features. The use of polycarbonate lenses, particularly in the United States, is widespread. The demand for sport goggles and sunglasses that are impact resistant has increased as a result of extensive outdoor activity.

These lenses are often produced by an injection molding process. In such a process, molded plastic lens or goggle plates are created by incorporating a polarizing film or by tinting with a dye. The former is preferred since a polarizing film will not only reduce the amount of light passing through the lens, but will also effectively reduce glare from roads, water, and other reflective surfaces.

One way to effectively incorporate a polarizing film into a plastic lens is described in U.S. Pat. No. 5,751,481. A polarizing laminate is constructed with a first transparent polymeric layer, a light polarizing layer, and a second transparent polymeric layer. A unitary laminate is cut from the laminate and formed into a lens blank of a given curvature under heat and pressure. The transparent polymeric sheet on the concave side is substantially thicker than the polymeric sheet on the convex side. The concave side polymeric sheet is thick enough to allow the polarized lens blank to be grinded into an ophthalmic polarized lens. This method works well for lenses with simple optical design, but is not suited for progressive or flat-top multi-focal lenses. Further, the process of this method is tedious and time consuming.

A more efficient and effective method to incorporate light polarization into a lens manufactured from a thermoplastic material is insert injection molding. For example, U.S. Pat. Nos. 6,328,446 and 5,856,860, herein incorporated by reference, describe an insert injection molding method to manufacture polarized polycarbonate lenses. In this process, a polarizing plate wafer is first placed inside a mold cavity. Thermoplastic lens material is next injected into the cavity and fused to the back of the polarizing plate, producing a polarized polycarbonate lens. The polarizing plate is substantially thinner than the injected lens base, and is a laminate consisting of a polarizing film with one protective resin sheet and one support resin sheet bonded to each side of the polarizing film. The protective sheet forms the convex surface of the finished lens, while the support sheet provides the integration of the polarizing wafer to the lens base material.

Various polarizing plates or laminates have been previously disclosed. Examples include U.S. Pat. Nos. 4,387,133, 4,427,741, 4,592,623, 4,774,141, and 5,051,309. Polyvinyl alcohol (PVA) based polarizing films with either iodine or dichroic dyes as the polarizing element are most widely used. A polarizing plate comprising a PVA polarizing film is usually of a structure in which the protective layers of the polarizing film are of the same thermoplastic material. Various thermoplastics, such as cellulose triacetate, cellulose acetate butyrate, and polycarbonate, are used as protective layers to prolong the life of the polarizing film by increasing the heat resistance and moisture resistance, at the same time keeping the optical properties of the polarizing film.

Yet, there is still a need for a polarizing plate constructed with two protective resin sheets of different materials or compositions.

When such a polarizing plate is used to make a polarized optical article, the protective resin sheet provides the optical properties at the convex side, while the support resin sheet provides the thermal fusibility with the injected base material. In the case where the polarizing film contains iodine as the polarizing element, a protective sheet having lower softening temperature than the base material may also be advantageous due to lower mold temperature requirements. High mold temperature, as required for polycarbonate material for example, will cause discoloration of such a polarizing film and other performance degradation.

More recently, U.S. patent publication 2002/0044352 describes a polarizing composite, having a film attached to an ordinary polarizing plate. The film is made from the same material as the lens, while the polarizing composite contains three plastic resin layers, one polarizing film layer, and three adhesive layers. Unfortunately, this technique has increased the chance for defects due to particulates, poor adhesion, and other internal defects in the resin layers.

### BRIEF SUMMARY OF THE INVENTION

In accordance with this invention, a polarizing plate is provided for incorporating into a plastic optical article through insert injection molding. One embodiment of this polarizing plate is comprised of the following:

a substantially optically isotropic thermoplastic sheet as the protective layer;

a polarizing film;

a thermoplastic sheet as the support layer;

The protective layer faces the injection mold cavity surface with the support layer thermally fused with the injected material.

The thermoplastic sheet of the protective layer is made of an optical grade thermoplastic material that has minimal or zero induction of birefringence, and has a retardation value of less than about 200 nm. Suitable thermoplastics for the protective layer include cellulose esters, polycarbonates, cycloolefin copolymers, and syndiotactic polystyrenes. The thickness of the protective layer is preferably from about 0.1 mm to 0.8 mm.

The thermoplastic sheet for the support layer may be made of an optical grade, non-heat treated, non-oriented thermoplastic material. The support layer may have significant birefringence characteristics and exhibit a colored interference fringe under polarizing light. However, these deficiencies should not affect the use of the polarizing plate in optical parts. The thermoplastics material for the support layer is thermally fusible to the injected base material of the optical article. The support layer is comparable to the protective layer, preferably ranging from about 0.1 mm to 0.8 mm.

A polarizing wafer cut from the polarizing plate of this invention can be directly used in an insert injection molding process. For plastic lenses having a high diopter front (convex) surface, the wafers are preferably preformed into spherically curved shapes with a proper diopter.

The polarizing plate of this invention can be advantageously used to provide anti-glare performance to a plastic optical article such as a sunglass lens, a sport goggle, or a sun visor. It is especially advantageous to use the polarizing plate of the present invention in polycarbonate based ophthalmic lenses where the support layer is made of polycarbonate. In a preferred embodiment, the polarizing plate of this invention does not show colored interference fringe when observing with the protective layer facing to the polarized light.

The terms “film” and “thin layer” are used interchangeably. The terms “layer” and “sheet” are also used interchangeably. The terms “wafer”, “insert”, “unitary laminate”, and “unitary plate” are used interchangeably.

### DETAILED DESCRIPTION OF THE INVENTION

As an important component in the polarizing plate of this invention, the polarizing film only transmits light of a specific wave orientation. The typical polarizing film comprises a uniaxially stretched film comprising PVA or derivatives thereof having absorbed iodine or dichroic dyes as a polarizing element. Other polarizing film compositions include polyene sheets and dichroic sheets. A polyene polarizing sheet is created by dehydrochlorination of a polyvinyl chloride film or dehydration of a PVA film. A dichroic polarizing sheet is created by blending a hydrophobic resin (e.g., polyethylene teraphthalate) with a dichroic dye followed by uniaxially stretching. From the standpoint of polarization characteristics and heat resistance, dichroic dye polarizing sheets are preferred in this invention.

Adsorption and orientation of dichroic dyes or iodine can be carried out by methods commonly known to those skilled in the art. See for example, U.S. Pat. Nos. 4,774,141 and 4,992,218, which are incorporated by reference herein.

Examples of the dichroic substances (particularly dichroic dye) used to impart polarizing property to the polymeric film include Chlorantine Fast Red (C.I. 28160), Chrysophenine (C.I. 24895), Sirius Yellow (C.I. 29000), Benzopurpurine (C.I. 23500), Direct Fast Red (C.I. 23630), Brilliant Blue 6B (C.I. 24410), Chlorazol Black BH (C. 1. 22590), Direct Blue 2B (C.I. 22610), Direct Sky Blue (C.I. 24400), Diamine Green (C. 1. 30295), Congo Red (C.I. 22120), and Acid Black (C.I. 20470).

The polarizing plate of this invention may utilize a polarizing film based on polyene. A usable polyene polarizing film is disclosed in U.S. Pat. No. 5,666,223 as a K-sheet type polarizer. It is incorporated herein by reference.

The K-sheet is a light polarizer sheet comprising a molecularly oriented sheet of polyvinylalcohol/polyvinylene block copolymer material having the polyvinylene blocks thereof formed by the molecular dehydration of a sheet of polyvinylalcohol. The molecularly oriented sheet of polyvinylalcohol/polyvinylene block copolymer material comprises a uniform distribution of light-polarizing molecules of polyvinylalcohol/polyvinylene block copolymer material varying in the length (n) of the conjugated repeating vinylene unit of the polyvinylene block of the copolymer throughout the range of from 2 to 24. The sheet is stretched prior to, subsequent to, or during the dehydration step with the result that the light-polarizing molecules become oriented such that the degree of orientation of the molecules increases throughout the range with increasing length (n) of said polyvinylene blocks. Further, the concentration of each of the polyvinylene blocks remains comparatively constant (i.e., “balanced”) through 200 nm to 700 nm, thus providing balanced polarization.

While the K-sheet polarizing sheet can provide polarization efficiency higher than 99%, it usually does not give acceptable color to the optical article. Therefore, it is preferred to absorb desired color correction dye(s) into the film before or after the dehydration process. Incorporation of dyes can be achieved by the conventional method of soaking the film in a dye bath.

The polarizing plate of this invention may also use a hydrophobic polymer based polarizing film. Examples are polarizing films based on poly(ethylene terephthalate) or poly(ethylene naphthalate) as disclosed in U.S. Pat. No. 5,666,223, which is incorporated herein by reference. In order to obtain a hydrophobic polymer based polarizing film that has a desired color and particularly a neutral gray color, it is preferable to blend a number of hydrophobic dichroic dyes into the base polymer. Furthermore, non-dichroic dyes may be used to correct the color if necessary.

Another type of polarizing film that may be used in this invention is based on a liquid crystalline polymer (LCP). The LCP may be a polyester, a polyamide, a polycarbonate, a poly(ester-carbonate), polyaramide, poly(ester-amide), and the like. Example LCP's suitable for use as a polarizing film can be found in U.S. Pat. Nos. 5,738,803 and 5,746,949, incorporated herein by reference.

Thickness of the polarizing film is preferably between about 10 microns to 150 microns, more preferably between 30 microns to 102 microns.

The typical thermoplastic resin used for preparing the protective layer includes a cellulose ester, a polycarbonate, a norbornene resin (polycycloolefin), a syndiotactic polystyrene, an acrylic polymer, a copolymer of an acrylic monomer and styrene, copolymer of styrene and acrylonitrile, a polysulfone, and an amorphous polyester or copolyester. Of these, cellulose acetate butyrate and polycycloolefin are preferred in view of the minimum introduction of birefringence during forming and insert injection molding. In any event, it is desired that the retardation value of the protective layer be less than about 200 nm. The protective layer is preferred to be optically isotropic. In a preferred embodiment the retractive index of the protective layer is substantially the same in substantially all directions.

There are many types of cellulose ester resins that can be used to make the cellulose ester protective film. Examples are those esters of low fatty acids such as cellulose acetate butyrate (CAB), cellulose acetate, cellulose biacetate, and cellulose triacetate (CTA). It is preferred for the cellulose ester of choice to have a phthalic ester type plasticizer. The plasticizer can be loaded between about 10 to 20 wt. %. Commercially available cellulose ester film products include Kodacel® of Eastman Kodak Co., Fuji Tack Clear of Fuji Photo Film Co., Konicatac of Konica.

Various resins are used for manufacturing polycarbonate film. Aromatic polycarbonate is preferable and a bisphenol-A polycarbonate is especially preferable. Such a polycarbonate is obtained by employing 4,4′-dihydroxydiphenyl alkane or a halogenated compound thereof according to a phosgene method or an ester exchange reaction method. The 4,4′-dihydroxydiphenyl alkane includes 4,4′-dihydroxydiphenyl methane or 4,4′-dihydroxydiphenyl ethane or 4,4,′-dihydroxydiphenyl butane.

When a polycarbonate is selected, resins having high melt flow index (e.g., higher than 25) are preferred due to their minimum introduction of birefringence during forming and molding. Birefringence can severely effect the polarization quality of the polarizing plate. The polycarbonate used in the invention has a glass transition temperature (Tg) preferably between about 110° C. and 160° C.

The resin for preparing the preferably used norbornene resin sheet is a polymer comprising a norbornene monomer unit, and preferably a polyolefin having a norbornene structure. The typical example of the norbornene resin is Zeonor® by Zeon Chemicals, Topas® by Ticona, Arton® by Nihon Goseigomu Co., Ltd.

The resin for preparing the syndiotactic polystyrene resin sheet preferably used in the invention is a polystyrene resin having a stereo regularity, a syndiotactic structure, in which phenyl groups or substituted phenyl groups as a side chain are alternatively positioned on opposite sides to the polystyrene main chain. Generally, the film comprises polystyrene having mainly recemo chains in the polystyrene structure or a composition containing the polystyrene.

The protective films used in this invention may contain necessary additives such as plasticizer, UV absorber, light stabilizer, heat stabilizer, etc.

The polarizing plate of the present invention is intended for use in a plastic optical article where the protective layer faces the light source. In order to eliminate or greatly reduce the colored interference fringe, the protective film used preferably has a small retardation value. The polarizing plate of the invention has a protective film with a preferable retardation value of about 200 nm or less. A retardation of 100 nm or less is more preferable and can provide a polarizing plate with high performance.

The manufacturing method used according to this invention is not limited to protective film with a low retardation value. A conventional method such as melt-extrusion, melt casting, solution casting (band or drum) or a calendering method may be used. The solvent casting film is preferably used in view of it's excellent surface property, isotropy and reduced anisotropy.

The protective film of the invention has a preferred thickness of about 0.02 mm to 1.3 mm, and more preferably about 0.1 mm to 0.8 mm.

The support layer in this invention may have significant birefringence characteristics and exhibit colored interference fringe under polarizing light. However, these deficiencies should not affect the use of the polarizing plate in optical parts such as sunglasses, goggles, or sun visors. Although the support layer in this invention can be made from any optical grade thermoplastic sheet, it is preferable for the thermoplastic layer to be made from same or similar material as the optical article base material so that the polarizing plate can be thermally integrated with the article base body through injection molding process. Preferred thermoplastic materials for the support layer include cellulose esters, polycarbonate, polyimide, polyamide, polyurethane, polycyclicolefin or cyclic olefin copolymer, and polysulfone. Considering that most of molded polarized eyewear articles are based on polycarbonate, a thermoplastic support layer made from a polycarbonate sheet is more preferred.

The support layer can be made from any optical grade polycarbonate sheet. It may be a sheet produced from an ordinary polycarbonate resin, a polycarbonate copolymer resin (e.g., polyester-carbonate), or a blending of polycarbonate with other resin(s). It is preferred to use a polycarbonate derived from 4′,4′-dihydroxy-diphenyl-2,2-propane (bisphenol A) as a main component (in an amount of preferably at least about 80 mole %, particularly about 90 mole %).

The polycarbonate support layer can be produced with any industry standard manufacturing method, such as hot-melt extruding, calendering, or casting. There is no specific requirement for the retardation value of the polycarbonate sheet used as the support layer. Extruded sheets are preferred from the economic viewpoint. Examples of optical grade polycarbonate include GE Lexan®, Bayer Makrolon®, and Teijin Panlite®. Theses extruded sheets (or films) usually have a retardation value between 100 nm and 1000 nm.

The polysulfone resin sheet includes resin preferably comprising polysulfone, polyether sulfone and polyarylsulfone. Typical examples include poly(oxy-1,4-phenylene-1,4-phenylene) or poly(oxy-1,4-phenyleneisopropylidene-1,4-phenyleneoxy-1,4-phenylenesulfony I-1,4-phenylene).

Suitable thickness of the support layer in this invention is comparable to the thickness of the protective layer, ranging between about 0.02 mm to 1.3 mm, and preferably about 0.1 mm to 0.8 mm. The support layer does not need to be heat-treated or oriented.

The polarizing plate of the invention includes a plate in which the protective layer and the support layer are adhered to a polarizing film. An adhesive is used to adhere the thermoplastic protective layer and the thermoplastic support layer to the polarizing thin sheet. In order to adhere a thermoplastic sheet layer to a K-sheet type polarizing film, one of the following adhesives may be used: urethane type adhesive, a polyvinyl alcohol adhesive such as polyvinyl alcohol or polyvinyl butyral, and a vinyl latex adhesive such as butyl acrylate. A urethane type adhesive can also used for hydrophobic polymer based polarizing film. In LCP polarizing film it is typically difficult to bond the thermoplastic sheet layers to the LCP film. Hot melt adhesives such as the ADMER adhesive by Mitsui Petrochemical, Japan are needed. In order to have a still better adhesion between the thermoplastic sheet layer and the polarizing film, pre-treatment of the polarizing film surface and the thermoplastic sheet surface by methods commonly known to those skilled in the art is desired. Pre-treatment can be performed by chemical corrosion such as treating with alkali solution or by plasma discharge such as corona.

Polarized optical articles such as lenses with the polarizing plate of this invention can be advantageously manufactured by an insert injection molding process such as described in U.S. Pat. No. 6,328,446, which is incorporated herein by reference.

To incorporate the polarizing plate of this invention into plastic lenses, polarizing wafers are first cut from the polarizing plate. The size of the wafer is defined by the lenses to be molded. The cut can be made in a number of ways, including by rolling knife cutter, reciprocal stamping cutter, straight-edge cutting knife moved translationally along a cut-line, or a rotary or swing die traversed along a line or by laser cutter.

The wafers may be used directly or pre-formed into a given diopter. If forming is needed, the base curve diopter of the wafers is determined by the convex side curvature of the finished lenses. The forming process may be performed thermally with or without pressure or vacuum. In general, the thermoforming temperature is close to but lower than the glass transition temperature of the thermoplastic material used for the protective and support layers. For example, a suitable forming temperature for a polarizing plate with polycarbonate layers will be about 125° C. to 150° C.

A polarizing wafer is then placed in the injection mold cavity and lens base material is injection molded on the support layer of the wafer to produce a polarized plastic lens.

The polarizing plate and polarized plastic lenses in accordance with this invention will now be illustrated with reference to the following examples, which are not to be construed as a limitation upon the scope of the invention in any way.

### EXAMPLES

The following Examples and Comparative Examples illustrate the present invention more specifically.

In these examples, all values are expressions of weight %. Uvinul® 3040 available from BASF (Mount Olive, N.J., US) and Tinuvins® available from CIBA (Tarrytown, N.Y., US) are UV absorbers and stabilizers.

The following methods of measurement are used in these examples.

(1) The visible light transmission (VLT, %) is measured with a Hunter Lab UltraScan spectrophotometer.

(2) The parallel position VLT (T₀, the VLT of a structure obtained by aligning the polarizing axis of sample polarizing plate parallel to the axis of a standard gray polarizer), the right angle position VLT (T₉₀, the VLT of a structure obtained by aligning the polarizing axis of sample polarizing plate perpendicular to the axis of a standard gray polarizer) are measured to determine the degree of polarization. It is defined as following:

$$P = \sqrt{\frac{{T}_{0} - {T}_{90}}{{T}_{0} + {T}_{90}}} \times 100$$

(3) The retardation value (R, nm) is defined by the following equation.

Retardation value (R)=Δn·d

wherein Δn is the birefringence of the protective sheet, and d is the thickness (nm) of the sheet. The retardation value at 560 nm is measured under ambient condition with an automatic ellipsometry (VASE ellipsometer by J. A. Woollam Co.).

(4) The colored interference fringe was observed and evaluated by placing a sample polarizing plate, with the protective layer facing down, on top of an illuminated standard polarizer. Observation is done with naked eyes. The results were assigned to the following four ranks.

A: Hardly any colored interference fringe was noted.

B: A very slightly colored interference fringe was noted. This causes no problem in practice.

C: A lightly colored interference fringe was noted.

D: A marked interference fringe was noted.

### EXAMPLE 1

A cellulose acetate butyrate sheet having a thickness of 0.4 mm and a retardation value of 150 nm (protective layer) and a polycarbonate sheet having a thickness of 0.25 mm and variable retardation values from 15 nm to 350 nm across its area (support layer) were laminated by using a polyurethane adhesive onto each side of a gray polarizing film. The polarizing film is made from PVA and dichroic dyes and has a thickness of 0.03 mm. The polarizing plate has a single plate VLT of 17.2% and a degree of polarization 99.2% over the visible spectrum.

The polarizing plate was thermo-compression formed into a wafer having a 6-diopter curvature over a course of 10 minutes with the polycarbonate layer on the concave side. The forming temperatures for the concave and convex sides were 260° F. and 210° F., respectively. The resulting wafer has a single plate VLT of 17.1% and a degree of polarization 99.0%. No significant reduction of polarization was observed. When the wafer was placed on top of an illuminated instrumental polarizing plate with the cellulose acetate butyrate layer facing the polarizing source, colored interference fringe patterns were not observed. The result of observation was therefore in rank A.

### EXAMPLE 2

The materials in Example 1 were used except that the cellulose acetate butyrate sheet was replaced by a cast polycarbonate film having a thickness of 0.12 mm and a retardation value of 5 nm. The polarizing plate has a single plate VLT of 17.5% and a degree of polarization 99.1%.

The polarizing plate was formed into a 6-diopter wafer with the conditions in Example 1 except that the convex side temperature was 260° F. The resulting wafer has a single plate VLT of 17.1% and a degree of polarization 95.7%. No significant reduction of polarization was observed. When the wafer was placed on top of an illuminated instrumental polarizing plate, very light colored interference fringe patterns were observed. The result of observation was therefore in rank B.

### EXAMPLE 3

The materials in Example 1 were used except that the cellulose acetate butyrate sheet was replaced by a cast cellulose acetate sheet having a thickness of 0.25 mm and a retardation value of 70 nm. The polarizing plate has a single plate VLT of 15.8% and a degree of polarization 99.1%.

The polarizing plate was formed into a 6-diopter wafer with the conditions in Example 1. The resulting wafer has a single plate VLT of 17.0% and a degree of polarization 99.0%. No significant reduction of polarization was observed. When the wafer was placed on top of an illuminated instrumental polarizing plate with the cellulose acetate layer facing the polarizing source, colored interference fringe patterns were not observed. The result of observation was therefore in rank A.

The resulting wafer was placed in a mold cavity and polycarbonate melt was injected onto the polycarbonate layer of the wafer. A polarized polycarbonate lens with a cellulose acetate front layer was thus obtained. When the lens was placed on top of an illuminated instrumental polarizing plate with the cellulose acetate layer facing the polarizing source, colored interference fringe patterns were not observed. The result of observation was therefore in rank A.

### EXAMPLE 4

The materials in Example 1 were used except that the cellulose acetate butyrate sheet was replaced by a Zeonor resin sheet (Zeonex, Japan) having a thickness of 0.25 mm and a retardation value of 3 nm. The polarizing plate had a single plate VLT of 16.4% and a degree of polarization 99.5%.

The polarizing plate was form into a 6-diopter wafer with the conditions in Example 1 except that the convex side temperature was 230° F. The resulting wafer has a single plate VLT of 15.6% and a degree of polarization 98.6%. No significant reduction of polarization was observed. When the wafer was placed on top of an illuminated instrumental polarizing plate with the Zeonor® resin layer facing the polarizing source, colored interference fringe patterns were not observed. The result of observation was therefore in rank A.

### EXAMPLE 5

A polarizing plate laminated from a 0.34 mm thick cellulose acetate butyrate sheet (Kodacel®, Kodak), a 0.04 mm thick PVA polarizing film with iodine polarizing element, and 0.38 mm thick extruded polycarbonate sheet (GE, NY) was formed into a 3-diopter wafer with the cellulose acetate butyrate layer on the convex side. Insert injection molding polycarbonate lens material onto the polycarbonate side of the polarizing wafer resulted a 76 mm diameter polarized polycarbonate lens with 4-diopter convex surface. The mold block temperature was 30° C. lower than the temperature used for molding regular polarizing wafers having polycarbonate sheet as both protective and support layers. No discoloration of the polarizing wafer was observed with bare eyes. After the polarized lens was surfaced down to 2 mm thick, the VLT was measured to be 13.5%, and polarization efficiency 99%.

### COMPARATIVE EXAMPLE 1

Example 2 was repeated using the polycarbonate support sheet on both side of the polarizing film. Marked interference fringe patterns evaluated as rank C was observed even before the forming.

What is claimed is:

1. A plastic optical article manufactured by an insert injection molding process comprising:
an injection molded, thermoplastic lens base;
a laminated polarizing wafer bonded to said injected molded, thermoplastic lens base, said laminated polarizing wafer comprising in order:
a) a substantially optically isotropic thermoplastic sheet as a protective layer;
b) a polarizing film, and
c) a thermoplastic sheet as a support layer,
wherein said substantially optically isotropic thermoplastic sheet has a retardance of less than about 200 nm, and the support layer is thermally fused to said thermoplastic lens base.

2. A plastic optical article of claim 1 wherein the protective layer comprises a thermoplastic selected from the following group: a cellulose ester, a polyacrylate, a cycloolefin copolymer.

3. A plastic optical article of claim 1 wherein the support layer is a polycarbonate sheet.

4. A plastic optical article of claim 1 wherein the protective layer is a cellulose ester sheet, and the support layer is a polycarbonate sheet.

5. A plastic optical article of claim 1 wherein the protective layer is a polyacrylate having a glass transition temperature of higher than 80° C., and the support layer is a polycarbonate sheet.

6. A plastic optical article of claim 1 wherein said polarizing film is a polyvinyl alcohol film doped with at least one dichroic dye.

7. A plastic optical article of claim 1 wherein said polarizing film is a polyvinyl alcohol film containing polyvinylene light polarizing elements.

8. A plastic optical article of claim 1 wherein said polarizing film is a poly(ethylene terephthalate) film with at least one dichroic dye.

9. A method of making an optical article comprising:
providing a substantially optically isotropic thermoplastic sheet as a protective layer;
applying a polarizing film it against said substantially optically isotropic thermoplastic sheet;
applying a thermoplastic support sheet against said polarizing film; and
thermally fusing said thermoplastic support sheet to an injection molded thermoplastic lens base.

10. The method of making an optical article of claim 9 wherein the protective layer comprises a thermoplastic selected from the following group: a cellulose ester, a polyacrylate, or a cycloolefin copolymer.

11. The method of making an optical article of claim 9 wherein the support layer is a polycarbonate sheet.

12. The method of making an optical article of claim 9 wherein the protective layer is a cellulose ester sheet, and the support layer is a polycarbonate sheet.

13. The method of making an optical article of claim 9 wherein the protective layer is a polyacrylate having a glass transition temperature of higher than 80° C., and the support layer is a polycarbonate sheet.

14. The method of making an optical article of claim 9 wherein said polarizing film is a polyvinyl alcohol film doped with at least one dichroic dye.

15. The method of making an optical article of claim 9 wherein said polarizing film is a polyvinyl alcohol film containing polyvinylene light polarizing elements.

16. The method of making an optical article of claim 9 wherein said polarizing film is a poly(ethylene terephthalate) film with at least one dichroic dye.

17. A polarized optical article comprising:
a thermoplastic support sheet;
a polarizing film disposed adjacent to said thermoplastic support sheet; and
a substantially optically isotropic thermoplastic front sheet disposed adjacent to said polarizing film, wherein said substantially optically isotropic thermoplastic sheet has a retardance of less than about 200 nm.

18. A polarized optical articles according to claim 17, wherein said protective layer comprises a thermoplastic selected from the following group: a cellulose ester, a polyacrylate, a cycloolefin copolymer.

19. A polarized optical article of claim 17 wherein the support layer is a polycarbonate sheet.

20. A polarized optical article of claim 17 wherein the protective layer is a cellulose ester sheet, and the support layer is a polycarbonate sheet.
